(19) United States
(12) Patent Application Publication
(10) Pub. No.: US 2026/0175850 A1
(43) Pub. Date: Jun. 25, 2026

(54) POSE INFORMATION CONTINUITY FOR AUTONOMOUS VEHICLE FAULT RECOVERY

(71) Applicant: Zoox, Inc., Foster City, CA (US)

(72) Inventors: Liren Cheng, Los Altos, CA (US); Marcello Daniele Guarro, Santa Cruz, CA (US); Nathaniel Jon Kaiser, Fremont, CA (US)

(21) Appl. No.: 18/991,215

(22) Filed: Dec. 20, 2024

(51) Int. Cl. B60W 50/02; B60W 60/00

(52) U.S. Cl. CPC B60W 50/0225; B60W 60/00186

(57) ABSTRACT

Techniques are discussed herein for restoring autonomous vehicle operations after one or more onboard computer systems have failed. An autonomous vehicle may comprise a primary compute node (PCN), an active motion compute node (MCN) and a backup MCN. During a first “nominal” mode, the active MCN can supply first vehicle pose information for use by the PCN. If the active MCN experiences a fault, the autonomous vehicle can enter a second “emergency” mode in which the backup MCN supplies second vehicle pose information for use by the PCN. As part of its restoration operations, the active MCN can use a snapshot of the second vehicle pose information as a starting point to resume computing the first vehicle pose information.

### BACKGROUND

Autonomous vehicle control systems may include multiple different computer systems. In the event of a fault or failure at one computer system, the other computer systems may remain available to perform at least limited autonomous vehicle control.

In some cases, a computer system that experienced a fault may be restored, and the restored computer system becomes available to resume its normal functions. In such scenarios, it is preferable to configure the autonomous vehicle to return to normal operation as quickly and smoothly as possible.

### BRIEF DESCRIPTION OF THE DRAWINGS

FIG. 1 is a pictorial diagram illustrating example vehicle control mode transitions of an autonomous vehicle which experiences a fault of one or more onboard computer systems, in accordance with one or more examples of the disclosure.

FIGS. 2A-2D illustrate example interconnected computer systems configured to cooperate to control an autonomous vehicle, an example fault and fault recovery experienced at one of the computer systems, and changes in a supply of pose information in response to the fault and fault recovery, in accordance with one or more examples of the disclosure.

FIG. 3 illustrates example vehicle control mode state transitions of an autonomous vehicle, including state transitions of an example first computer system, second computer system, and third computer system, in accordance with one or more examples of the disclosure.

FIG. 4 illustrates example computer systems configured to cooperate to control an autonomous vehicle and components thereof, in accordance with one or more examples of the disclosure.

FIG. 5 depicts a block diagram of an example system including an autonomous vehicle, in accordance with one or more examples of the disclosure.

FIG. 6 is a flow diagram illustrating an example process for controlling an autonomous vehicle according to different vehicle control modes before, during and after a fault at one or more of the autonomous vehicle's onboard computer systems, in accordance with one or more examples of the disclosure.

### DETAILED DESCRIPTION

This disclosure describes techniques for restoring autonomous vehicle operations after one or more onboard computer systems have failed. An autonomous vehicle may comprise multiple computer systems, including, e.g., at least one primary compute node (PCN) and at least two motion compute nodes (MCNs). The MCNs can include an active (or primary) MCN and a backup MCN. Both the active and the backup MCNs can independently compute vehicle pose information. The vehicle pose information can include, e.g., three dimensional vehicle position coordinates and vehicle roll, pitch, and yaw values.

During a first “nominal” mode, a controller associated with active MCN may have primary responsibility for executing a vehicle trajectory (e.g., a trajectory generated by the PCN) to move the vehicle through an environment. The active MCN can also include functionality to determine vehicle state information. In some specific examples of this disclosure, the active MCN can include functionality, e.g., a solver, configured to iteratively determine first vehicle pose information. The active MCN may use the first vehicle pose information to execute the vehicle trajectory, for example. In examples, the state information generated by the active MCN, e.g., the first vehicle pose information, may also be used by other systems on the vehicle, e.g., the PCN(s). For example, the active MCN can publish the first vehicle pose information.

If the active MCN experiences a fault, the autonomous vehicle can enter a second “emergency” or “safe” mode. In the “safe” mode, the backup MCN assumes responsibility for executing a vehicle trajectory, e.g., a “safe” trajectory. The backup MCN can also include functionality to determine vehicle state information. In some specific examples of this disclosure, the backup MCN can include functionality, e.g., a solver, configured to iteratively determine second vehicle pose information. The backup MCN may use the second vehicle pose information to execute the safe trajectory, for example. In examples, the state information generated by the backup MCN, e.g., the second vehicle pose information, may also be used by other systems on the vehicle, e.g., the PCN(s). For example, the backup MCN can publish the second vehicle pose information.

Generally, the backup MCN may be at least partially redundant of the active MCN. For instance, the backup MCN may be engaged when the active MCN is unavailable, untrustworthy, or the like, e.g., because of a fault or other event. In one non-limiting example, in the event of a fault, the safe mode may be engaged in which the backup MCN may bring the vehicle to a stop.

While the vehicle is controlled in the safe mode, the active MCN may be restored to functionality and, once the restoration is successful, control of the vehicle may be “returned” to the active MCN, e.g., for continued operation in the normal mode. Aspects of this disclosure may be particularly directed to this restoration and return of functionality. For example, as part of its restoration operations, the active MCN can use a snapshot of the second vehicle pose information as a starting point to resume computing the first vehicle pose information. The snapshot can include, e.g., an instance of the second vehicle pose information at a point in time, which may be recorded by a timestamp.

After resuming the first vehicle pose information, the active MCN can optionally check alignment between the resumed first vehicle pose information and the second vehicle pose information. If the first vehicle pose information and the second vehicle pose information are sufficiently aligned, the autonomous vehicle can resume operations according to the first “nominal” mode, in which the active MCN again supplies the first vehicle pose information for use by the PCN.

Autonomous vehicles can comprise multiple different computing systems that cooperate to control the vehicle. In one example arrangement, an autonomous vehicle may have two PCNs as well as two MCNs. Each of these elements can optionally reside on a different computing device, and each can have a different role in autonomous vehicle control. Furthermore, the computing systems can be connected by a vehicle-based network, so the vehicles can communicate and cooperate to control the autonomous vehicle.

For example, a first PCN may be primarily equipped to perform prediction and planning functions, e.g., computing and selecting vehicle trajectories. A second PCN may be primarily equipped to perform perception functions, e.g., processing sensor inputs to build a representation of an environment surrounding the autonomous vehicle. The representation generated by the second PCN can be used by the first PCN in connection with its prediction and planning functions. Meanwhile, an example first (active) MCN can process selected trajectories produced by the first PCN and can translate the selected trajectories into control instructions for autonomous vehicle systems, such as steering and speed controls. An example second (backup) MCN can remain available in the event that the first MCN experiences a failure, allowing the autonomous vehicle to remain operable by the fully functioning first and second PCNs, even when the first MCN fails.

Autonomous vehicles can also optionally include a collision avoidance system (CAS) which is equipped to take over control of the vehicle in the event that an imminent collision or other imminent danger is detected. In such situations, the CAS may maneuver the vehicle in order to avoid the collision or other danger. The CAS may be implemented across one or more of the PCNs and MCNs.

Procedures described herein can implement an MCN takeback approach for a first, active MCN to take back control of an autonomous vehicle after a second, backup MCN takeover. The techniques described herein can optionally allow for MCN takeback without a full vehicle power cycle, if the active MCN is healthy enough to do so. The disclosed MCN takeback procedures can also optionally be initiated via remote control, e.g., by a teleoperator with a remote communication connection to an autonomous vehicle. One goal may be to continue an autonomous mission after a backup MCN takeover while a vehicle remains in service, without necessarily sending a recovery crew.

In some examples, after an autonomous vehicle executes a backup MCN takeover, which may include stopping the autonomous vehicle, e.g., in a stationary position in the middle of a lane, the autonomous vehicle may disengage from autonomous or “nominal” operation. To resume an autonomous mission after active MCN takeback, the autonomous vehicle may re-engage autonomous operation. After an active MCN takeback, the autonomous vehicle may be configured to attempt to resume a previous mission under autonomous operation. In the event that an active MCN takeback cannot successfully allow an autonomous vehicle to continue its mission in autonomous mode, the autonomous vehicle can be configured to enter a manual (human controlled), a teleoperated mode, or some other mode.

Should an active MCN experience a fault, pose information calculated by the active MCN may become unavailable, untrustworthy, or inaccurate. For example, as a result of the fault, the active MCN may be shut down and re-initialized. Accordingly, pose information may not have been generated or updated properly at the active MCN during a fault recovery period. For example, consider an autonomous vehicle driving in a straight line on an x-axis at ten (10) meters per second. Accurate pose information may include increments very close to 10 meters on the autonomous vehicle's x position. If the pose information doesn't change at all or only increments 1 meter during a fault period, the resulting pose information would be inaccurate and must be corrected. Furthermore, large jumps (changes) in pose information in one clock tick are not desirable. For example, even if an autonomous vehicle is stationary, if its x position changes from x0 at time t0 to ‘x0+10’ at time ‘t0+5 ms’, such a jump may lead to other problems in autonomous vehicle control.

In an example, a takeover by a backup MCN may be triggered at a first time, t1. The takeover by the backup MCN may finish at a second time, t2. An active MCN may attempt to re-establish autonomous vehicle operations at a third time, t3. A duration d1 may include the time between t1 and t2, i.e., the duration of takeover by the backup MCN.

During the backup MCN takeover period d1, the active MCN's pose information may not be accurate. For example, if inertial measurement unit (IMU) data or drive dynamics data used by the active MCN is stale for several seconds, then active MCN pose information may be generated incorrectly. The active MCN pose information may nonetheless be smooth without “jump” during the backup MCN takeover period d1. On the other hand, the backup MCN pose information is likely to be accurate enough to meet safety requirements in the period d2 if the backup MCN is functioning properly.

Aspects of this disclosure can provide a pose information self-recovery capability for an active MCN. After an active MCN takeback is triggered, the active MCN and other autonomous vehicle systems can use the techniques described herein to “self-recover” from faults, allowing the active MCN to restore calculating and sending (or otherwise providing, publishing, storing, communicating, receiving, or causing access to) pose information for use by the autonomous vehicle, e.g., by a PCN.

In an example restart scenario, an active MCN pose calculation process can be restarted as part of the active MCN takeback procedure. The active MCN pose calculation process can first initialize, which may optionally require the autonomous vehicle to be stationary for a period of time, such as 1-30 seconds. After initialization, the active MCN pose calculation process can begin publishing pose information to an autonomous vehicle's onboard network, so the pose information is available to other onboard computer systems.

In accordance with some examples herein, an active MCN may synchronize its pose information with backup MCN pose information during active MCN takeback. An embedded gateway component of a PCN may be configured to send a snapshot of backup MCN pose information to the active MCN, in response to the backup MCN returning autonomous vehicle control back to the active MCN. The active MCN pose calculation function can apply the backup MCN pose information to reset, or otherwise adjust the active MCN's pose information.

The embedded gateway component can be configured to avoid publishing active MCN pose information prior to reset of the active MCN's pose information from the backup MCN snapshot. After observing the backup MCN is no longer in control, the embedded gateway can continue to publish and use the backup MCN pose information. This way, embodiments can avoid the use of active MCN pose information prior to adjustment/reset of the active MCN pose information.

The embedded gateway can optionally confirm that the active MCN pose information has been corrected/reset using the backup MCN snapshot through the use of an indicator or flag. The indicator or flag can be generated and provided for example by the active MCN after resetting its pose information.

The techniques described herein can be implemented in a number of ways. Examples are provided below with reference to the following figures. Although discussed in the context of an autonomous vehicle, the methods, apparatuses, and systems described herein can be applied to a variety of systems (e.g., a sensor system or a robotic platform), and are not limited to autonomous vehicles. In examples, similar techniques may be utilized in driver-controlled vehicles in which such a system may provide an indication of whether it is safe to perform various maneuvers.

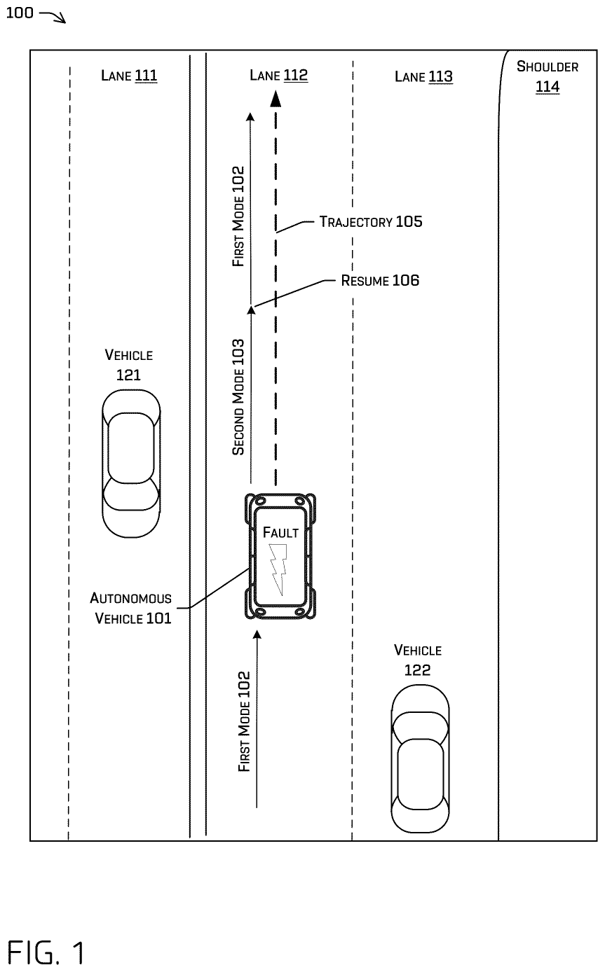

FIG. 1 is a pictorial diagram illustrating example vehicle control mode transitions of an autonomous vehicle which experiences a fault of one or more onboard computer systems, in accordance with one or more examples of the disclosure. FIG. 1 illustrates an example environment 100 including a first lane 111, a second lane 112, a third lane 113, and a shoulder 114. An autonomous vehicle 101 is traveling in the second lane 112, and the autonomous vehicle 101 has a trajectory 105. Other vehicles 121 and 122 are traveling in the first lane 111 and the third lane 113.

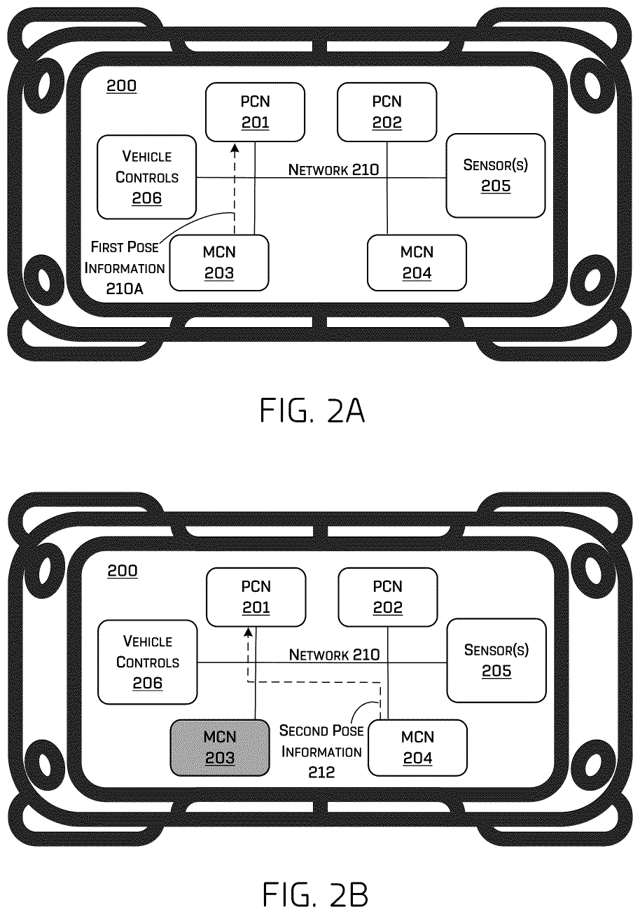

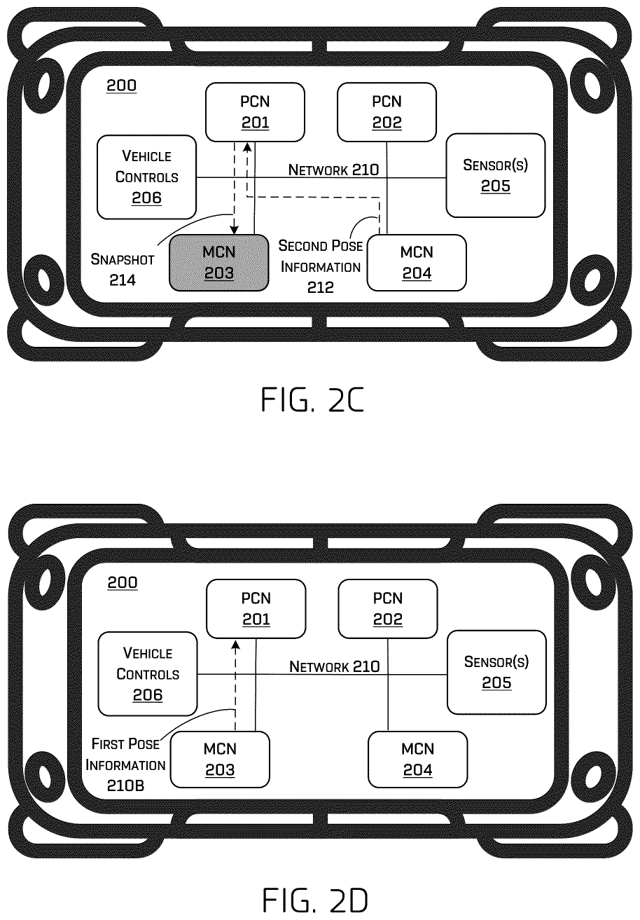

Prior to experiencing the fault, the autonomous vehicle 101 may be operating in a first mode 102, also referred to herein as a first vehicle control mode or a first operating mode. The first mode 102 can comprise a nominal or normal mode in which all computing systems onboard the autonomous vehicle 101 are substantially operational. In the first mode, vehicle control is implemented by the active MCN. Moreover, the active MCN will generate first vehicle state information, e.g., first pose information. The first vehicle state information may be supplied by the active MCN for use by other systems, e.g., for use by a PCN (shown in FIGS. 2A-2D).

As shown in FIG. 1, while the autonomous vehicle 101 is operating in the first mode 102, a fault is determined or detected at one or more of the computing systems. In an example according to this disclosure, the fault occurs at the active MCN.

In response to determining an occurrence of the fault, in the example of FIG. 1, the autonomous vehicle 101 enters a second mode 103, also referred to herein as an emergency or safe mode. In the second mode 103, vehicle control is implemented, e.g., by the backup MCN (shown in FIGS. 2A-2D). Moreover, the backup MCN generates the second vehicle state information, e.g., second pose information. The second vehicle state information generated by the backup MCN may be supplied for use by other systems, e.g., for use by the PCN (shown in FIGS. 2A-2D). While in the second mode 103, the autonomous vehicle 101 can attempt to reset or restore operability of the failed or faulted computing system, e.g., operability of the active MCN. In an example, the autonomous vehicle 101 may be controlled by the backup MCN to maintain the current lane (lane 112) and bring the autonomous vehicle 101 to a stop therein. However, in some examples, the backup MCN may be configured to perform other emergency functions, such as maintaining lane and speed, or navigating to the shoulder 114 or an exit and bringing the autonomous vehicle 101 to a stop.

If the faulted computing system, e.g., the active MCN, is successfully restored while the autonomous vehicle 101 is in the second mode 103, then subsequent to controlling the autonomous vehicle 101 in the second mode 103, a resume 106 enables the autonomous vehicle 101 to transition back into the first mode 102. All of the computing systems onboard the autonomous vehicle 101 can return to normal, or at least limited normal functioning and the autonomous vehicle 101 can proceed under functioning autonomous control.

As part of restoring the active MCN to enable the resume 106, the active MCN may be supplied with a snapshot of second pose information provided by the backup MCN, as described herein. The active MCN can reset its first pose information based on the second pose information included in the snapshot, and the active MCN can continue to calculate first pose information from initial values represented in the snapshot. The backup MCN can continue to calculate second pose information after the time of the snapshot, and the active MCN can check alignment of its first pose information against second pose information calculated by the backup MCN. If alignment is sufficiently within alignment thresholds, the active MCN can notify the PCN that the first pose information is reliable, and the PCN can switch back to consuming the first pose information produced by the active MCN.

If the faulted computing system, e.g., the active MCN, is not successfully restored while the autonomous vehicle 101 is in the second mode 103, then other steps can optionally be taken, such as entering a teleoperation mode for remote operation by a teleoperator or calling a response team to repair and/or recover the autonomous vehicle 101.

FIGS. 2A-2D illustrate example interconnected computer systems configured to cooperate to control an autonomous vehicle, an example fault and fault recovery experienced at one of the computer systems, and changes in a supply of pose information in response to the fault and fault recovery, in accordance with one or more examples of the disclosure. Each of FIGS. 2A-2D includes an example autonomous vehicle 200 equipped with a PCN 201, a PCN 202, a first, active MCN 203, and a second, backup MCN 204, all connected to a network 210. Also connected to the network 210 are example sensor(s) 205 and example vehicle controls 206.

In the illustrated example, the PCN 201 can be configured to include a first set of functions, e.g., prediction and planner functions, and the PCN 202 can be configured to include a second set of functions, e.g., perception functions. The sensor(s) 205 can comprise, e.g., vision sensors such as cameras and LIDAR sensors, as well as any other sensors. The sensor(s) 205 are connected to the network 210 and therefore sensor data can optionally be retrieved by any of the PCN 201, PCN 202, active MCN 203, or backup MCN 204. The vehicle controls 206 can comprise, e.g., a vehicle steering system and vehicle speed control systems such as braking and acceleration systems. The vehicle controls 206 are connected to the network 210 and therefore can optionally be accessed by any of the PCN 201, PCN 202, first MCN 203, or second MCN 204 to carry out vehicle control commands.

In FIG. 2A, PCN 201, PCN 202, active MCN 203, and backup MCN 204 are all substantially operable, no fault has been determined, and therefore the autonomous vehicle 200 can operate in the first, normal operating mode described herein. In the first mode, sensor data from the sensor(s) 205 may be primarily consumed by the PCN 202 which comprises the perception functions in this example. The PCN 202 can provide environment information to the PCN 201 which comprises the prediction and planner functions in this example. The PCN 201 can generate trajectories, and the active MCN 203 can control the autonomous vehicle 200 by controlling the vehicle controls 206 according to the generated trajectories.

In the first mode, the active MCN 203 can also independently calculate and provide first pose information 210A to the PCN 201, and the PCN 201 can use the first pose information 210A in connection with its calculations and functions. The backup MCN 204 can also independently calculate second pose information, however, the second pose information need not be provided to the PCN 201, as the PCN 201 can rely on the first pose information 210A.

FIG. 2B illustrates an example failure at the active MCN 203, represented by the gray shading of the active MCN 203. In FIG. 2B, a fault has been determined at the active MCN 203, however, the PCN 201, PCN 202, and backup MCN 204 remain substantially operable. In response to the fault, the backup MCN 204 can begin supplying second pose information 212 to the PCN 201. The PCN 201 can continue to operate despite the fault at the active MCN 203, by switching to use of the second pose information 212 in place of the first pose information 210A. The active MCN 203 can optionally begin restoration/reset/re-initialization operations immediately, or the active MCN 203 can optionally wait for a predetermined interval prior to attempting reset. In some embodiments, the active MCN 203 can wait until the autonomous vehicle 200 has stopped prior to attempting reset.

In FIG. 2C, the active MCN 203 is continuing reset operations, as indicated by gray shading. The backup MCN 204 is continuing to provide second pose information 212 for use by the PCN 201. The active MCN 203 has reached a point in its reset procedures at which the active MCN 203 is ready to resume independently calculating and communicating first pose information to the PCN 201. In order to reset first pose information, the active MCN 203 can be provided with a snapshot 214 of current second pose information 212. The snapshot 214 can comprise, e.g., pose information values as well as a timestamp. The active MCN 203 can use the snapshot 214 as a starting point for calculating first pose information 210B, shown in FIG. 2D.

FIG. 2D illustrates a restored active MCN 203, no longer in shading to indicate a return to operability. The restored active MCN 203 is publishing or otherwise communicating restored first pose information 210B for use by the PCN 201. The backup MCN 204 need not continue to provide the second pose information 212 for use by the PCN 201.

Prior to publishing the restored first pose information 210B for use by the PCN 201 as illustrated in FIG. 2D, the active MCN 203 can optionally check alignment of the first pose information 210B and the second pose information 212, by retrieving subsequent second pose information 212 (subsequent to the snapshot 214) and comparing it to subsequent first pose information 210B (also subsequent to the snapshot 214). If the first pose information 210B and the second pose information 212 are satisfactorily aligned, as determined by alignment thresholds, then the active MCN 203 can re-initiate publishing first pose information 210B to the PCN 201. The active MCN 203 can optionally send to the PCN 201 an indication or flag which indicates that the first pose information 210B is good/reliable/aligned/ready for use.

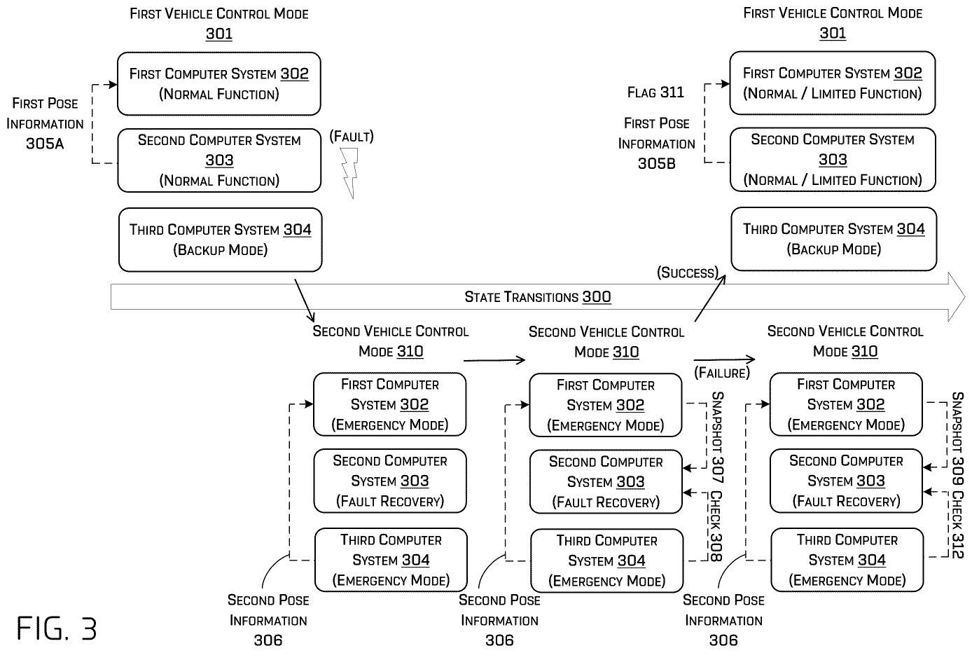

FIG. 3 illustrates example vehicle control mode state transitions 300 of an autonomous vehicle, including state transitions of an example first computer system 302, second computer system 303, and third computer system 304, in accordance with one or more examples of the disclosure. In the illustrated example, the first computer system 302 corresponds to the PCN 201 illustrated in FIGS. 2A-2D, the second computer system 303 corresponds to the active MCN 203 illustrated in FIGS. 2A-2D, and the third computer system 304 corresponds to the backup MCN 204 illustrated in FIGS. 2A-2D.

FIG. 3 includes a first state in which the autonomous vehicle is in a first vehicle control mode 301. In examples, the first vehicle control mode 301 may correspond to the first mode 102 discussed above. While the autonomous vehicle is in the first vehicle control mode 301, the first computer system 302 and the second computer system 303 exhibit normal functioning, and the third computer system 304 is in backup mode which also corresponds to normal function. The second computer system 303 can independently calculate first pose information 305A, use first pose information 305A to execute vehicle trajectories, and provide first pose information 305A for use by the first computer system 302. Meanwhile, the third computer system 303 can also independently calculate second pose information, however, the second pose information need not be used for vehicle control or provided to the first computer system 302. In some examples, the third computer system 303 need not independently calculate second pose information and can instead consume the first pose information 305A in order to maintain updated pose information. After some period of time in the first vehicle control mode 301, a fault may be determined at one of the vehicle's onboard computer systems, e.g., a fault may be determined at the second computer system 303.

In response to detecting the fault, the autonomous vehicle can be configured to switch into a second vehicle control mode 310. While the autonomous vehicle is in the second vehicle control mode 310, a fault recovery process is performed at the second computer system 303 in an attempt to restore the second computer system 303 to its nominal functioning mode. The other remaining computer systems, e.g., the first computer system 302 and the third computer system 304, can function in emergency mode. For example, the first computer system 302 can modify vehicle trajectories to stop the autonomous vehicle in lane or otherwise perform emergency safety maneuvers. The third computer system 304 can independently calculate and provide second pose information 306 for use by the first computer system 302. The third computer system 304 can also control motion of the autonomous vehicle in accordance with emergency trajectories to stop the autonomous vehicle in lane or otherwise perform emergency safety maneuvers.

The autonomous vehicle can remain in the second vehicle control mode 310 as the second computer system 303 either retrieves or is provided with a snapshot 307 of the second pose information 306. The second computer system 303 can use the snapshot 307 to reset its calculations of the first pose information, thereby allowing the second computer system 303 to begin generating the restored first pose information 305B. The second computer system 303 can furthermore perform a check 308 in order to check alignment of the restored first pose information 305B against the second pose information 306.

If the alignment check fails, then the autonomous vehicle can remain in the second vehicle control mode 310 as the second computer system 303 retrieves or is provided with a second snapshot 309 of the second pose information 306. The second computer system 303 can use the second snapshot 309 to reset its calculations of the first pose information, thereby allowing the second computer system 303 to re-initialize the first pose information 305B. The second computer system 303 can furthermore perform a second check 312 in order to check alignment of the restored first pose information 305B against the second pose information 306. In the event of multiple alignment check failures, the autonomous vehicle can remain in the second vehicle control mode 310 as the second computer system 303 performs up to a limited number, e.g., up to 3-8 repeated attempts to initialize the first pose information 305B. If the first pose information 305B cannot be re-initialized, then the autonomous vehicle can move itself into another emergency mode, e.g., calling a recovery team or entering tele-operation.

If the alignment check succeeds, then the autonomous vehicle can return to the first vehicle control mode 301, in which the first computer system 302 and the second computer system 303 return to normal or, optionally, limited normal function. Normal function can allow for full return to an autonomous mission, while limited normal function may comprise sufficient function to move the autonomous vehicle into a safe parking location or return the autonomous vehicle to a home base. The third computer system 304 can return to backup mode per normal function as well.

In order to return to normal or limited normal function, the second computer system 303 can send a flag 311 or other indication to the first computer system 302, which indicates that the first pose information 305B is acceptable for use, e.g., by being sufficiently threshold aligned with the second pose information 306. The second computer system 303 can begin publishing the first pose information 305B to a vehicle network or can otherwise provide the first pose information 305B for use by the first computer system 302.

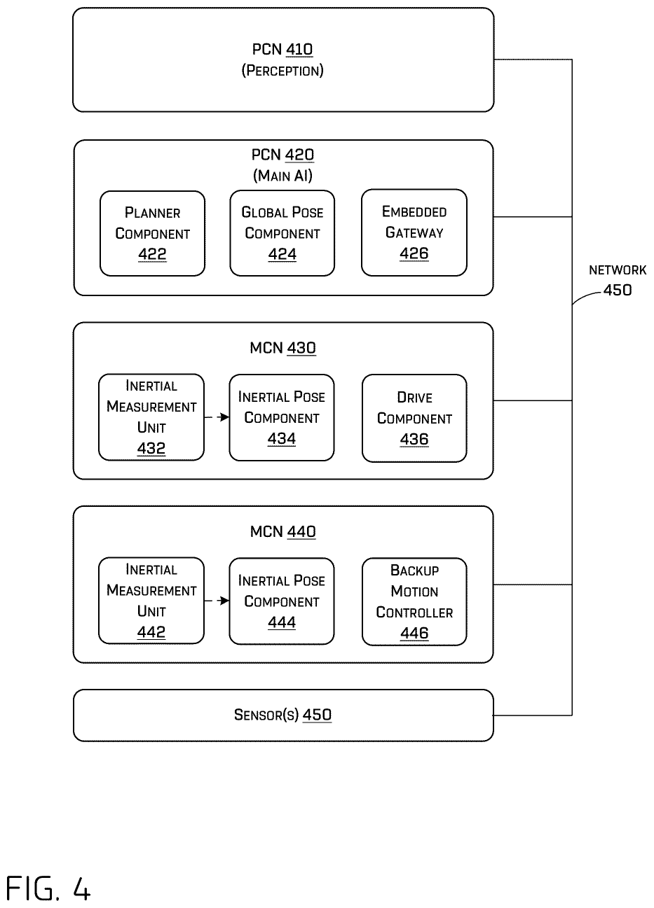

FIG. 4 illustrates example computer systems configured to cooperate to control an autonomous vehicle and components thereof, in accordance with one or more examples of the disclosure. The illustrated example computer systems can implement the PCN 201, PCN 202, MCN 203, and MCN 204, introduced in FIGS. 2A-2D, in some embodiments. FIG. 4 includes a PCN 410, a PCN 420, an MCN 430, an MCN 440, sensor(s) 450, and a network 460. The illustrated PCN 410, PCN 420, MCN 430, MCN 440, and sensor(s) 450 can each provide functions to support autonomous vehicle operations and can communicate via the network 460.

The PCN 410 can be adapted to generally provide perception functions and can include various components not shown in FIG. 4 for simplicity of this description. The PCN 420 can be adapted to generally provide main AI functions, and can include, e.g., a planner component 422, a global pose component 424, and an embedded gateway 426, as well as various components not shown in FIG. 4 for simplicity of this description. The MCN 430 can be adapted to generally provide active MCN functions and can include an inertial measurement unit (IMU) 432, an inertial pose component 434, and a drive component 436, as well as various components not shown in FIG. 4 for simplicity of this description. The MCN 440 can be adapted to generally provide backup MCN functions and can include an inertial measurement unit (IMU) 442, an inertial pose component 444, and a backup motion controller 446, as well as various components not shown in FIG. 4 for simplicity of this description.

In an example according to FIG. 4, during normal mode operation, the PCN 410 performs perception functions based on input from the sensor(s) 450. The PCN 420 relies on perception inputs from the PCN 410 as well as first pose information from the MCN 430 to generate global pose information, via the global pose component 424, and to generate autonomous vehicle trajectories, via the planner component 422. The PCN 420 communicates with other computer systems via the embedded gateway 426.

The MCN 430 uses the drive component 436 to control motion of the autonomous vehicle, based on trajectories generated by the PCN 420. The MCN 430 furthermore uses inertial pose component 434 to generate first pose information, and the MCN 430 repeatedly provides updated first pose information to the PCN 420. In order to generate the first pose information, the inertial pose component 434 processes inputs from the inertial measurement unit (IMU) 432, as well as other inputs from sensor(s) 450. The inertial pose component 434 can optionally be implemented as an integrator-based solver that integrates inputs from the IMU 432 as well as other sensors in order to solve for vehicle pose information.

The MCN 440 remains in a backup state, wherein the MCN 440 is ready to use the backup motion controller 446 to control motion of the autonomous vehicle if needed. The MCN 440 furthermore uses its inertial pose component 444 to generate second pose information. In order to generate the second pose information, the inertial pose component 444 processes inputs from an IMU 442 implemented at the MCN 440, as well as other inputs from sensor(s) 450. Like the inertial pose component 434, the inertial pose component 444 can optionally be implemented as an integrator-based solver that integrates inputs from the IMU 442 as well as other sensors in order to solve for vehicle pose information.

Should the MCN 430 experience a fault, then the autonomous vehicle can enter second, emergency mode operation. During emergency mode operation, the PCN 410 can continue to perform perception functions based on input from the sensor(s) 450. The PCN 420 relies on perception inputs of the PCN 410 as well as second pose information from the MCN 440 to generate global pose information, via the global pose component 424, and to generate autonomous vehicle trajectories, via the planner component 422. The PCN 420 may generate a limited emergency trajectory, e.g., causing the autonomous vehicle to stop in lane or perform a limited maneuver to navigate to safety.

The MCN 430 ceases using the drive component 436 to control motion of the autonomous vehicle, and instead enters fault recovery operations. The MCN 440 begins using the backup motion controller 446 to control motion of the autonomous vehicle. The MCN 440 continues using its inertial pose component 444 to generate second pose information and begins publishing the second pose information to the embedded gateway 426 for use by the PCN 420.

After the MCN 430 has partially recovered from the fault, the embedded gateway 426 can provide a snapshot of the second pose information to the MCN 430. The MCN 430 can use the snapshot to reset its inertial pose component 434 and can begin generating first pose information based on the snapshot and any subsequent inputs from the IMU 432 and/or other sensor(s) 450. The MCN 430 can check alignment of its first pose information with second pose information produced by the MCN 440. If alignment thresholds are satisfied, the MCN 430 can notify the embedded gateway 426 that the first pose information is acceptable, and the embedded gateway 426 can return to use of the first pose information in connection with PCN 420 functions. The MCN 430 and other components can return to normal mode operations, described above.

In another aspect, the MCN 430 can optionally correct for potential startup bias in the IMU 432 as a part of fault recovery. IMU 432 may experience a startup bias for example if the IMU 432 has been powered off. The MCN 430 can determine IMU 432 bias values based on an output from a second IMU, such as the IMU 442. The MCN 430 can then use the bias values to adjust outputs from the IMU 432 prior to using the outputs from the IMU 432 to determine first pose information.

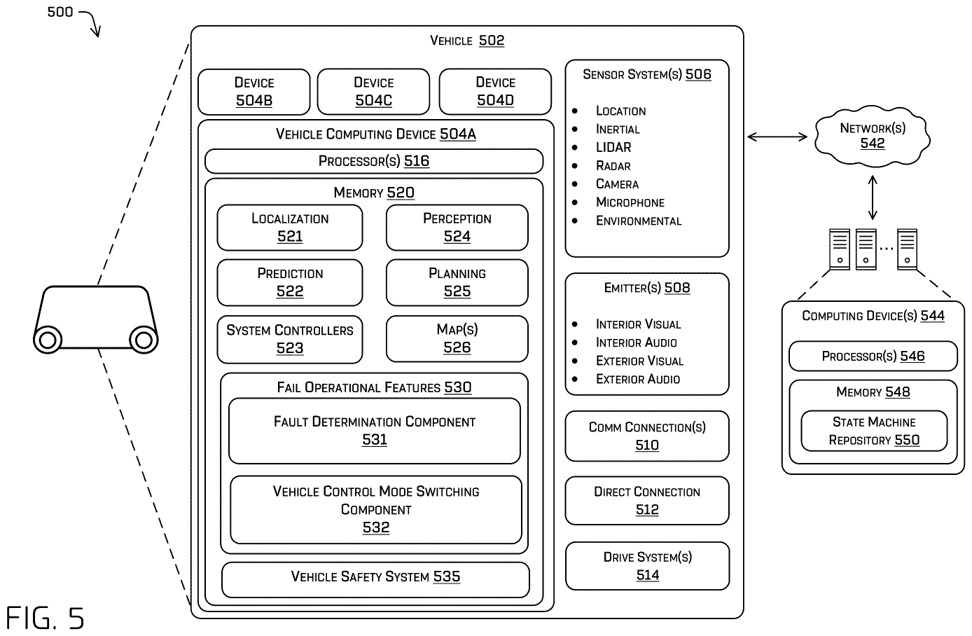

FIG. 5 depicts a block diagram of an example system 500 including an autonomous vehicle 502, in accordance with one or more examples of the disclosure. The system 500 can include the vehicle 502, which can correspond to an autonomous or semi-autonomous vehicle configured to perform various techniques described herein. As shown in this example, vehicle 502 may include components configured to switch from the use of first pose information to the use of second pose information in response to a fault at one or more of the vehicle 502 computer systems and subsequently switch back to the use of first pose information, after recovery of the faulted vehicle 502 computer systems.

The example vehicle 502 can be a driverless vehicle, such as an autonomous vehicle configured to operate according to a Level 5 classification issued by the U.S. National Highway Traffic Safety Administration, which describes a vehicle capable of performing all safety-critical functions for the entire trip, with the driver (or occupant) not being expected to control the vehicle at any time. In such examples, because the vehicle 502 can be configured to control all functions from start to completion of a trip, including all parking functions, it may or may not include a driver and/or controls for driving the vehicle 502, such as a steering wheel, an acceleration pedal, and/or a brake pedal. This is merely an example, and the systems and methods described herein may be incorporated into any ground-borne, airborne, or waterborne vehicle, including those ranging from vehicles that need to be manually controlled by a driver at all times, to those that are partially or fully autonomously controlled.

The vehicle 502 may include vehicle computing devices 504A, 504B, 504C, and 504D, one or more sensor systems 506, one or more emitters 508, one or more communication connections 510, at least one direct connection 512, and one or more drive systems 514.

The vehicle computing devices 504A-D can implement the computing devices described in connection with FIGS. 1-4 in some examples. For example, the vehicle computing devices 504A-D can comprise, e.g., a first PCN such as PCN 201 illustrated in FIGS. 2A-2D, a second PCN such as PCN 202 illustrated in FIGS. 2A-2D, a first MCN such as MCN 203 illustrated in FIGS. 2A-2D, and a second MCN such as MCN 204 illustrated in FIGS. 2A-2D. Each of the vehicle computing devices 504A-D can include one or more processors and a memory communicatively coupled with the one or more processors. For example, computing device 504A comprises one or more processors 516 and memory 520 communicatively coupled with the one or more processors 516. In the illustrated example, the vehicle 502 is an autonomous vehicle; however, the vehicle 502 could be any other type of vehicle or robotic platform.

In the illustrated example, the memory 520 of the vehicle computing device 504A can store various functions such as a localization component 521, a prediction component 522, system controllers 523, a perception component 524, a planning component 525, and one or more maps 526. Some of the example functions 521-526 can be implemented on, e.g., the vehicle computing device 504A while others of the example functions 521-526 can be implemented on, e.g., another of the vehicle computing devices 504B-D. The vehicle computing device 504A can furthermore comprise, e.g., fail operational features 530, including a fault determination component 531 and a vehicle control mode switching component 532.

Though depicted in FIG. 5 as residing in the memory 520 for illustrative purposes, one or more of the localization component 521, prediction component 522, system controllers 523, perception component 524, planning component 525, maps 526, and fail operational features 530 can additionally, or alternatively, be accessible to the vehicle 502 (e.g., stored on, or otherwise accessible by, memory remote from the vehicle 502).

As shown in this example, the vehicle 502 also may also include a vehicle safety system 535, such as a collision avoidance system. The vehicle safety system 535 may be configured to generate, validate, and select an output trajectory for the vehicle 502. For instance, the vehicle safety system 535 may include a trajectory manager, which may include one or more trajectory generator(s), one or more trajectory validator(s), and/or a trajectory selector. The vehicle safety system 535 can be implemented separately from the fail operational features 530 disclosed herein.

By way of example, the vehicle computing device 504A may be considered to be a primary system, while the fail operational features 530 and the vehicle safety system 535 may be considered to be secondary systems. The primary system may generally perform processing to control how the vehicle maneuvers within an environment. The primary system within the vehicle computing device 504A may implement various artificial intelligence (AI) techniques, such as machine learning, to understand an environment around the vehicle 502 and/or instruct the vehicle 502 to move within the environment. The various components of the primary system, such as the localization component 521, prediction component 522, perception component 524, and planning component 525 may implement AI techniques to localize the vehicle, detect objects around the vehicle, segment sensor data, determine classifications of the objects, predict object tracks, generate trajectories for the vehicle 502 and the objects around the vehicle, and so on. In some examples, the primary system may process data from multiple types of sensors on the vehicle, such as light detection and ranging (lidar) sensors, radar sensors, image sensors, depth sensors (time of flight, structured light, etc.), cameras, and the like, within the sensor systems 506.

The fail operational features 530 and vehicle safety system 535 in this example may operate as separate systems that receive state data (e.g., perception data) based on the sensor data and AI techniques implemented by the primary system (e.g., vehicle computing device 504A), and may perform various techniques described herein for improving vehicle safety and operation, such as switching sources of pose information, or collision prediction and avoidance. The fail operational features 530 and vehicle safety system 535 may implement techniques for determining predicted trajectories and predicting intersections/collisions based on the predicted trajectories, as well as probabilistic techniques that are based on positioning, velocity, acceleration, etc. of the vehicle and/or objects around the vehicle.

In some examples, the fail operational features 530 and vehicle safety system 535 may process data from sensors, such as a subset of sensor data that is processed by the primary system. To illustrate, the primary system may process lidar data, radar data, image data, depth data, etc., while the fail operational features 530 and vehicle safety system 535 may process just lidar data and/or radar data (and/or time of flight data). In other examples, however, the fail operational features 530 and vehicle safety system 535 may process sensor data from any number of sensors, such as data from each of the sensors, data from the same number of sensors as the primary system, etc.

Although depicted in FIG. 5 as residing in the memory 520 for illustrative purposes, it is contemplated that the localization component 521, prediction component 522, system controllers 523, perception component 524, planning component 525, maps 526, and fail operational features 530 may additionally, or alternatively, be accessible to the vehicle 502 (e.g., stored on, or otherwise accessible by, memory remote from the vehicle 502, such as, for example, on memory 554 of a remote computing device 544).

In at least one example, the localization component 521 may include functionality to receive data from the sensor system(s) 506 to determine a position and/or orientation of the vehicle 502 (e.g., one or more of an x-, y-, z-position, roll, pitch, or yaw). For example, the localization component 521 may include and/or request/receive a map of an environment and may continuously determine a location and/or orientation of the autonomous vehicle within the map. In some instances, the localization component 521 may utilize SLAM (simultaneous localization and mapping), CLAMS (calibration, localization and mapping, simultaneously), relative SLAM, bundle adjustment, non-linear least squares optimization, or the like to receive image data, LIDAR data, radar data, IMU data, GPS data, wheel encoder data, and the like to accurately determine a location of the autonomous vehicle. In some instances, the localization component 521 may provide data to various components of the vehicle 502 to determine an initial position and/or trajectory of the vehicle 502, as discussed herein.

In some instances, and in general, the perception component 524 can include functionality to perform object detection, segmentation, and/or classification. In some examples, the perception component 524 can provide processed sensor data that indicates a presence of an entity that is proximate to the vehicle 502 and/or a classification of the entity as an entity type (e.g., car, pedestrian, cyclist, animal, building, tree, road surface, curb, sidewalk, stoplight, stop sign, unknown, etc.).

In additional or alternative examples, the perception component 524 can provide processed sensor data that indicates one or more characteristics associated with a detected entity (e.g., a tracked object) and/or the environment in which the entity is positioned. In some examples, characteristics associated with an entity can include, but are not limited to, an x-position (global and/or local position), a y-position (global and/or local position), a z-position (global and/or local position), an orientation (e.g., a roll, pitch, yaw), an entity type (e.g., a classification), a velocity of the entity, an acceleration of the entity, an extent of the entity (size), etc. Characteristics associated with the environment can include, but are not limited to, a presence of another entity in the environment, a state of another entity in the environment, a time of day, a day of a week, a season, a weather condition, an indication of darkness/light, etc.

In general, the prediction component 522 can include functionality to generate predicted information associated with objects in an environment. As an example, the prediction component 522 can be implemented to predict locations of a pedestrian proximate to a crosswalk region (or otherwise a region or location associated with a pedestrian crossing a road) in an environment as they traverse or prepare to traverse through the crosswalk region.

As another example, the techniques discussed herein can be implemented to predict locations of other objects (e.g., vehicles, bicycles, pedestrians, and the like) as the vehicle 502 traverses an environment. In some examples, the prediction component 522 can generate one or more predicted positions, predicted velocities, predicted trajectories, etc., for such target objects based on attributes of the target object and/or other objects proximate the target object.

In general, the planning component 525 can determine a path for the vehicle 502 to follow to traverse the environment. The planning component 525 can include functionality to determine various routes and trajectories and various levels of detail. For example, the planning component 525 can determine a route to travel from a first location (e.g., a current location) to a second location (e.g., a target location). For the purpose of this discussion, a route can be a sequence of waypoints for travelling between two locations. As non-limiting examples, waypoints include streets, intersections, global positioning system (GPS) coordinates, etc.

Further, the planning component 525 can generate an instruction for guiding the autonomous vehicle along at least a portion of the route from the first location to the second location. In at least one example, the planning component 525 can determine how to guide the autonomous vehicle from a first waypoint in the sequence of waypoints to a second waypoint in the sequence of waypoints. In some examples, the instruction can be a trajectory, or a portion of a trajectory. In some examples, multiple trajectories can be substantially simultaneously generated (e.g., within technical tolerances) in accordance with a receding horizon technique, wherein one of the multiple trajectories is selected for the vehicle 502 to navigate.

In some instances, the planning component 525 can generate one or more trajectories for the vehicle 502 based at least in part on predicted location(s) associated with object(s) in an environment. In some examples, the planning component 525 can use temporal logic, such as linear temporal logic and/or signal temporal logic, to evaluate one or more trajectories of the vehicle 502.

In at least one example, the vehicle computing device 504A can include one or more system controllers 523, which can be configured to control steering, propulsion, braking, safety, emitters, communication, and other systems of the vehicle 502. These system controller(s) 523 can communicate with and/or control corresponding systems of the drive system(s) 514 and/or other components of the vehicle 502. The controllers 523 illustrated in FIG. 5 correspond to the vehicle controls 206 illustrated in FIGS. 2A-2D.

For example, the planning component 525 may generate instructions based at least in part on perception data generated by the perception component 524 and transmit the instructions to the system controller(s) 523, which may control operation of the vehicle 502 based at least in part on the instructions. In some examples, if the planning component 525 receives a notification that a track of an object was “lost” (e.g., an object no longer appears in perception data and isn't occluded by any other objects), the planning component 525 may generate an instruction to bring the vehicle 502 to a safe stop and/or to transmit a request for teleoperator assistance.

The memory 520 can further include one or more maps 526 that can be used by the vehicle 502 to navigate within the environment. For the purpose of this disclosure, a map can be any number of data structures modeled in two dimensions, three dimensions, or N-dimensions that are capable of including information about an environment, such as, but not limited to, topologies (such as intersections), streets, mountain ranges, roads, terrain, and the environment in general.

In some instances, a map can include, but is not limited to: texture information (e.g., color information (e.g., RGB color information, Lab color information, HSV/HSL color information), and the like), intensity information (e.g., lidar information, radar information, and the like); spatial information (e.g., vectorized information regarding features of an environment, image data projected onto a mesh, individual “surfels” (e.g., polygons associated with individual color and/or intensity)), reflectivity information (e.g., specularity information, retroreflectivity information, BRDF information, BSSRDF information, and the like). In one example, a map can include a three dimensional mesh of the environment. In some instances, the map can be stored in a tiled format, such that individual tiles of the map represent a discrete portion of an environment and can be loaded into working memory as needed. In at least one example, the one or more maps 526 can include at least one map (e.g., images and/or a mesh).

In some examples, the vehicle 502 can be controlled based at least in part on the maps 526. That is, the maps 526 can be used in connection with the localization component 521, the perception component 524, the prediction component 522, and/or the planning component 525 to determine a location of the vehicle 502, identify objects in an environment, and/or generate routes and/or trajectories to navigate within an environment. In some examples, the one or more maps 526 can be stored on a remote computing device(s), such as within the memory 548 of the computing device(s) 544 and may be accessible to the vehicle 502 via network(s) 542. In some examples, multiple maps 526 can be retrieved from the memory 548, and stored based on, for example, a characteristic (e.g., type of entity, time of day, day of week, season of the year, etc.). Storing multiple maps 526 can have similar memory requirements but can increase the speed at which data in a map can be accessed.

In at least one example, the fault determination component 531 may include functionality to determine, by a first vehicle computing device 504A, whether a fault has occurred at another of the vehicle computing devices 504B-D. Several technical approaches can be used to implement the fault determination component 531.

In an example technical approach, the fault determination component 531 can be configured to monitor fault logs generated by vehicle computing devices 504B-D. The vehicle computing devices 504A-D can be configured to log any fault conditions that occur, including for example fault types, fault times, and affected systems. The fault determination component 531 can monitor such logs continuously or periodically, and when a fault of one or more predetermined fault types occurs, the fault determination component 531 can initiate the vehicle control mode switching component 532, e.g., to switch computer systems into an emergency operation mode.

In another example technical approach, the fault determination component 531 can be configured to monitor heartbeat signals output from other vehicle computing devices 504B-D. If a computing device stops producing its heartbeat signal as expected, then the fault determination component 531 can be configured to responsively initiate the vehicle control mode switching component 532.

As can be understood, the components discussed herein (e.g., localization component 521, prediction component 522, system controllers 523, perception component 524, planning component 525, maps 526, and fail operational features 530) are described as divided for illustrative purposes. However, the operations performed by the various components can be combined or performed in any other component. Further, any of the components discussed as being implemented in software can be implemented in hardware, and vice versa. Further, any functionality implemented in the vehicle 502 can be implemented in the computing device(s) 544, or another component (and vice versa).

The sensor system(s) 506 correspond to the sensor(s) 205 illustrated in FIGS. 2A-2D. In at least one example, the sensor system(s) 506 can include time of flight sensors, lidar sensors, radar devices and/or radar sensors, ultrasonic transducers, sonar sensors, location sensors (e.g., GPS, compass, etc.), inertial sensors (e.g., inertial measurement units (IMUs), accelerometers, magnetometers, gyroscopes, etc.), cameras (e.g., RGB, IR, intensity, depth, etc.), microphones, wheel encoders, environment sensors (e.g., temperature sensors, humidity sensors, light sensors, pressure sensors, etc.), etc.

The sensor system(s) 506 can include multiple instances of each of these or other types of sensors. For instance, the time-of-flight sensors can include individual time of flight sensors located at the corners, front, back, sides, and/or top of the vehicle 502. As another example, the camera sensors can include multiple cameras disposed at various locations about the exterior and/or interior of the vehicle 502.

The sensor system(s) 506 can provide input to the vehicle computing devices 504A-D. Additionally or alternatively, the sensor system(s) 506 can send sensor data, via the one or more networks 542, to the one or more computing device(s) 544 at a particular frequency, after a lapse of a predetermined period of time, in near real-time, etc.

The vehicle 502 can also include one or more emitters 508 for emitting light and/or sound, as described above. The emitters 508 in this example include interior audio and visual emitters to communicate with passengers of the vehicle 502. By way of example and not limitation, interior emitters can include speakers, lights, signs, display screens, touch screens, haptic emitters (e.g., vibration and/or force feedback), mechanical actuators (e.g., seatbelt tensioners, seat positioners, headrest positioners, etc.), and the like.

The emitters 508 in this example also include exterior emitters. By way of example and not limitation, the exterior emitters in this example include lights to signal a direction of travel or other indicator of vehicle action (e.g., indicator lights, signs, light arrays, etc.), and one or more audio emitters (e.g., speakers, speaker arrays, horns, etc.) to audibly communicate with pedestrians or other nearby vehicles, one or more of which comprising acoustic beam steering technology.

The vehicle 502 can also include one or more communication connection(s) 510 that enable communication between the vehicle 502 and one or more other local or remote computing device(s). For instance, the communication connection(s) 510 can facilitate communication with other local computing device(s) on the vehicle 502 and/or the drive system(s) 514. Also, the communication connection(s) 510 can allow the vehicle to communicate with other nearby computing device(s) (e.g., other nearby vehicles, traffic signals, etc.). The communications connection(s) 510 also enable the vehicle 502 to communicate with a remote teleoperation computing device or other remote services.

The communications connection(s) 510 can include physical and/or logical interfaces for connecting the vehicle computing devices 504A-D to another computing device or a network, such as network(s) 542. For example, the communications connection(s) 510 can enable Wi-Fi-based communication such as via frequencies defined by the IEEE 802.11 standards, short range wireless frequencies such as Bluetooth®, cellular communication (e.g., 2G, 3G, 4G, 4G LTE, 5G, etc.) or any suitable wired or wireless communications protocol that enables the respective computing device to interface with the other computing device(s).

In at least one example, the vehicle 502 can include one or more drive systems 514. The vehicle 502 can have a single drive system 514, or multiple drive systems 514. In at least one example, if the vehicle 502 has multiple drive systems 514, individual drive systems 514 can be positioned on opposite ends of the vehicle 502 (e.g., the front and the rear, etc.).

In at least one example, the drive system(s) 514 can include one or more sensor systems to detect conditions of the drive system(s) 514 and/or the surroundings of the vehicle 502. By way of example and not limitation, the sensor system(s) can include one or more wheel encoders (e.g., rotary encoders) to sense rotation of the wheels of the drive modules, inertial sensors (e.g., inertial measurement units, accelerometers, gyroscopes, magnetometers, etc.) to measure orientation and acceleration of the drive module, cameras or other image sensors, ultrasonic sensors to acoustically detect objects in the surroundings of the drive system, lidar sensors, radar sensors, etc. Some sensors, such as the wheel encoders can be unique to the drive system(s) 514. In some cases, the sensor system(s) on the drive system(s) 514 can overlap or supplement corresponding systems of the vehicle 502 (e.g., sensor system(s) 506).

The drive system(s) 514 can include many of the vehicle systems, including a high voltage battery, a motor to propel the vehicle, an inverter to convert direct current from the battery into alternating current for use by other vehicle systems, a steering system including a steering motor and steering rack (which can be electric), a braking system including hydraulic or electric actuators, a suspension system including hydraulic and/or pneumatic components, a stability control system for distributing brake forces to mitigate loss of traction and maintain control, an HVAC system, lighting (e.g., lighting such as head/tail lights to illuminate an exterior surrounding of the vehicle), and one or more other systems (e.g., cooling system, safety systems, onboard charging system, other electrical components such as a DC/DC converter, a high voltage junction, a high voltage cable, charging system, charge port, etc.).

Additionally, the drive system(s) 514 can include a drive system controller which can receive and preprocess data from the sensor system(s) and to control operation of the various vehicle systems. In some examples, the drive system controller can include one or more processors and memory communicatively coupled with the one or more processors. The memory can store one or more components to perform various functionalities of the drive system(s) 514. Furthermore, the drive system(s) 514 also include one or more communication connection(s) that enable communication by the respective drive system with one or more other local or remote computing device(s).

In at least one example, the direct connection 512 can provide a physical interface to couple the one or more drive system(s) 514 with the body of the vehicle 502. For example, the direct connection 512 can allow the transfer of energy, fluids, air, data, etc. between the drive system(s) 514 and the vehicle 502. In some instances, the direct connection 512 can further releasably secure the drive system(s) 514 to the body of the vehicle 502.

In at least one example, the localization component 521, the perception component 524, the prediction component 522, the planning component 525, the system controllers 523, and the maps 526, can process sensor data, as described above, and can send their respective outputs, over the one or more network(s) 542, to one or more computing device(s) 544. In at least one example, the respective outputs of the components can be transmitted to the one or more computing device(s) 544 at a particular frequency, after a lapse of a predetermined period of time, in near real-time, etc.

Additionally, or alternatively, the vehicle 502 can send sensor data to one or more computing device(s) 544 via the network(s) 542, including raw sensor data, processed sensor data and/or representations of sensor data. Such sensor data can be sent as one or more log files to the computing device(s) 544 at a particular frequency, after a lapse of a predetermined period of time, in near real-time, etc.

The computing device(s) 544 can include processor(s) 546 and a memory 548 storing a state machine repository 550. In some examples, a state machine repository 550 may store one or more state transition models that can be generated and modified offline and provided to various vehicles 502 in a fleet. Different state transition models may be provided to different models of vehicles 502, and/or based on the location or operating conditions of the vehicles 502.

In various examples, the computing devices 544 may implement one or more machine learning systems or heuristics-based systems to train, test, and optimize different state transition models for different vehicles 502 operating within different environments. Additionally, any of the features or functionalities described in connection with the vehicle fail operational features 530 may be performed by computing devices 544.

The processor(s) 516 of the vehicle 502 and the processor(s) 546 of the computing device(s) 544 can be any suitable processor capable of executing instructions to process data and perform operations as described herein. By way of example and not limitation, the processor(s) 516 and 546 can comprise one or more Central Processing Units (CPUs), Graphics Processing Units (GPUs), or any other device or portion of a device that processes electronic data to transform that electronic data into other electronic data that can be stored in registers and/or memory. In some examples, integrated circuits (e.g., ASICs, etc.), gate arrays (e.g., FPGAs, etc.), and other hardware devices can also be considered processors in so far as they are configured to implement encoded instructions.

Memory 520 and 548 are examples of non-transitory computer-readable media. The memory 520 and 548 can store an operating system and one or more software applications, instructions, programs, and/or data to implement the methods described herein and the functions attributed to the various systems. In various examples, the memory can be implemented using any suitable memory technology, such as static random-access memory (SRAM), synchronous dynamic RAM (SDRAM), nonvolatile/Flash-type memory, or any other type of memory capable of storing information. The architectures, systems, and individual elements described herein can include many other logical, programmatic, and physical components, of which those shown in the accompanying figures are merely examples that are related to the discussion herein.

It should be noted that while FIG. 5 is illustrated as a distributed system, in alternative examples, components of the vehicle 502 can be associated with the computing device(s) 544 and/or components of the computing device(s) 544 can be associated with the vehicle 502. That is, the vehicle 502 can perform one or more of the functions associated with the computing device(s) 544, and vice versa.

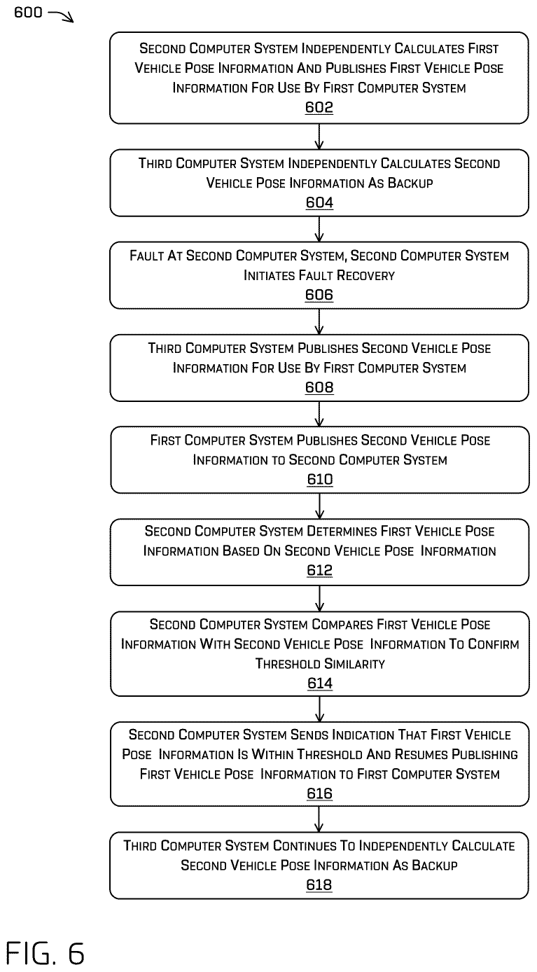

FIG. 6 is a flow diagram illustrating an example process for controlling an autonomous vehicle according to different vehicle control modes before, during and after a fault at one or more of the autonomous vehicle's onboard computer systems, in accordance with one or more examples of the disclosure. As described below, the process 600 may be performed by one or more computer-based components configured to implement various functionalities described herein.

The process 600 is illustrated as collections of blocks in a logical flow diagram, representing sequences of operations, some or all of which can be implemented in hardware, software, or a combination thereof. In the context of software, the blocks represent computer-executable instructions stored on one or more computer-readable media that, when executed by one or more processors, perform the recited operations. Generally, computer-executable instructions include routines, programs, objects, components, encryption, deciphering, compressing, recording, data structures, and the like that perform particular functions or implement particular abstract data types. The order in which the operations are described should not be construed as a limitation. Any number of the described blocks can be combined in any order and/or in parallel to implement the processes, or alternative processes, and not all of the blocks need to be executed in all examples. For discussion purposes, the processes herein are described in reference to the frameworks, architectures and environments described in the examples herein, although the processes may be implemented in a wide variety of other frameworks, architectures, or environments.

At operation 602, a second computer system, e.g., the active MCN 203 introduced in FIGS. 2A-2D, independently calculates first vehicle pose information and provides the first vehicle pose information for use by a first computer system, e.g., the PCN 201 illustrated in FIGS. 2A-2D. The first vehicle pose information can be calculated, e.g., based on information output from at least one sensor, such one or more of an inertial measurement unit (IMU), a wheel speed sensor, or a steering angle sensor. The first vehicle pose information can comprise, e.g., vehicle coordinates such as x, y, and z coordinates optionally along with information such as a vehicle roll angle, a vehicle pitch angle, and/or a vehicle yaw angle. The active MCN 203 can optionally provide the first vehicle pose information by sending, publishing, storing or otherwise communicating the first vehicle pose information to a vehicle network 210. Publishing the first vehicle pose information for use by the first computer system can comprise continuously or repeatedly calculating updated pose information, and continuously or repeatedly publishing vehicle pose information updates for use by the first computer system.

At operation 604, a third computer system, e.g., the backup MCN 204 introduced in FIGS. 2A-2D, can independently calculate second vehicle pose information. The second vehicle pose information is calculated as a backup and need not be provided for use by the PCN 201. Like the first vehicle pose information, the second vehicle pose information can be calculated, e.g., based on information output from at least one sensor, such one or more of an IMU, a wheel speed sensor, or a steering angle sensor. Also, the second vehicle pose information can comprise, e.g., vehicle coordinates such as x, y, and z coordinates optionally along with information such as a vehicle roll angle, a vehicle pitch angle, and/or a vehicle yaw angle. In some embodiments, the backup MCN 204 can rely at least in part on the first vehicle pose information to determine the second vehicle pose information.

At operation 606, a fault is observed at the second computer system and the onboard computer systems responsively enter a second mode. For example, the second computer system (active MCN 203) can initiate fault recovery. Fault recovery can be initiated immediately, or after a waiting period such as 5-30 seconds, and/or optionally after the vehicle is maneuvered into a safe position. The backup MCN 204 can begin serving as the vehicle's motion controller. The PCN 201 may change its trajectory calculations to maneuver the vehicle to safety.

At operation 608, in response to the fault at the second computer system, the third computer system (backup MCN 204) can begin publishing the second vehicle pose information for use by the first computer system (PCN 201). The backup MCN 204 can optionally provide the second vehicle pose information by sending, publishing, storing or otherwise communicating the second vehicle pose information to the vehicle network 210. Publishing the second vehicle pose information for use by the first computer system can comprise continuously or repeatedly calculating updated pose information, and continuously or repeatedly publishing vehicle pose information updates for use by the first computer system.

At operation 610, the first computer system (PCN 201) can provide the second vehicle pose information, e.g., a snapshot of the second vehicle pose information, to the second computer system (active MCN 203) to enable the second computer system to reset the first vehicle pose information based on the second vehicle pose information. The PCN 201 can optionally send a snapshot after it detects the active MCN 203 has reached a recovery stage that is considered ready for pose calculation. An embedded gateway 426 can optionally be configured to provide or publish the snapshot for use by the active MCN 203.

At operation 612, the second computer system (active MCN 203) can determine the first vehicle pose information based on the second vehicle pose information. For example, the active MCN 203 can re-initialize or reset its first pose information calculations using the second vehicle pose information from the snapshot, and the active MCN 203 can continue calculating first pose information based on sensor inputs after such re-initialization. Alternatively, the active MCN 203 can determine an offset, correction, adjustment, or difference between first pose information and second pose information at the time of the snapshot, and the active MCN 203 can use the offset, correction, or difference in its first pose information determinations.

At operation 614, the second computer system (active MCN 203) can compare the first vehicle pose information with the second vehicle pose information. The active MCN 203 and the backup MCN 204 can continue to update first vehicle pose information and second vehicle pose information, respectively, after the active MCN 203 has reset the first vehicle pose information. Therefore, subsequent to resetting the first vehicle pose information, the active MCN 203 can compare an updated first vehicle pose information to an updated second vehicle pose information, to confirm that the first vehicle pose information remains in alignment with the updated second vehicle pose information. Comparing the first vehicle pose information with the second vehicle pose information can comprise, e.g., confirming that the first vehicle pose information is threshold similar to the second vehicle pose information by first coordinates (of the first pose information) being less than a threshold distance from second coordinates (of the second pose information), or by first roll, pitch or yaw angle measurements being less than a threshold number of degrees from second roll, pitch or yaw angle measurements. Some example thresholds can include, e.g., anywhere from 1-50 centimeters for coordinate values, and anywhere from 0.5-5 degrees for roll, pitch, or yaw angle values.

At operation 616, the second computer system (active MCN 203) can provide, to the first computer system (PCN 201), an indication that the first vehicle pose information is threshold similar to the second vehicle pose information, as confirmed at operation 614, and the active MCN 203 can resume publishing the first vehicle pose information for use by the first computer system. The embedded gateway at the PCN 201 can begin using the first vehicle pose information for PCN 201 functions.

At operation 618, the third computer system (backup MCN 204) can continue to independently calculate second vehicle pose information as a backup, in case of future active MCN 203 faults. The backup MCN 204 can discontinue publishing or otherwise providing second vehicle pose information for use by the PCN 201.

### Example Clauses

A. A vehicle comprising: a first computer system comprising a primary compute node configured to generate trajectories for the vehicle; a second computer system comprising an active motion compute node configured to control the vehicle to follow the trajectories and to generate first vehicle pose information; and a third computer system comprising a backup motion compute node configured to control the vehicle to follow the trajectories and to generate second vehicle pose information; wherein each of the first, second, and third computer systems comprises one or more processors and one or more computer-readable media storing computer-executable instructions; wherein the instructions, when executed, implement an autonomous driving system that is configured for autonomous control of the vehicle; and wherein the instructions, when executed, cause the first, second and third computer systems to perform operations comprising: controlling, using the primary compute node and the active motion compute node, the vehicle in a first mode; publishing, with the vehicle in the first mode and by the active motion compute node, the first vehicle pose information for use by the primary compute node; in response to a fault at the active motion compute node, controlling, using the backup motion compute node, the vehicle in a safe mode; publishing, with the vehicle in the safe mode and by the backup motion compute node, the second vehicle pose information for use by the primary compute node; performing, with the vehicle in the safe mode, a fault recovery by the active motion compute node, the performing the fault recovery by the active motion compute node comprising: receiving the second vehicle pose information, and determining, by the active motion compute node and based on the second vehicle pose information, the first vehicle pose information; resuming, based at least in part on performing the fault recovery, the controlling the vehicle in the first mode; and resuming, based at least in part on performing the fault recovery, the publishing the first vehicle pose information for use by the primary compute node.
B. The vehicle of paragraph A, wherein the operations further comprise: subsequent to determining the first vehicle pose information based on the second vehicle pose information, comparing the first vehicle pose information with the second vehicle pose information by the active motion compute node, wherein comparing the first vehicle pose information with the second vehicle pose information comprises confirming that the first vehicle pose information is threshold similar to the second vehicle pose information; and publishing, by the active motion compute node to the primary compute node, an indication that the first vehicle pose information is threshold similar to the second vehicle pose information.
C. The vehicle of paragraph A, wherein the first vehicle pose information and the second vehicle pose information comprise vehicle position coordinates and vehicle roll, pitch, and yaw information.
D. The vehicle of paragraph A, wherein the active motion compute node independently calculates the first vehicle pose information based on information output from at least one sensor, the backup motion compute node independently calculates the second vehicle pose information based on information output from the at least one sensor, and the at least one sensor comprises one or more of an inertial measurement unit, a wheel speed sensor, or a steering angle sensor.
E. A method comprising: independently calculating, by a second computer system, first vehicle pose information based on information output from at least one sensor; independently calculating, by a third computer system, second vehicle pose information based on information output from the at least one sensor; publishing, by the second computer system, the first vehicle pose information for use by a first computer system to enable the first computer system to perform one or more vehicle control functions; in response to a fault at the second computer system, publishing, by the third computer system, the second vehicle pose information for use by the first computer system; performing a fault recovery by the second computer system; adjusting, by the second computer system, the first vehicle pose information based on the second vehicle pose information; and resuming the independently calculating, by the second computer system, the first vehicle pose information and the publishing, by the second computer system, the first vehicle pose information for use by the first computer system.
F. The method of paragraph E, wherein the independently calculating the first vehicle pose information is performed by an integrator-based solver at the second computer system.
G. The method of paragraph E, further comprising comparing the first vehicle pose information with the second vehicle pose information by the second computer system in order to confirm that the first vehicle pose information is threshold similar to the second vehicle pose information.
H. The method of paragraph G, further comprising publishing, by the second computer system to the first computer system, an indication that the first vehicle pose information is threshold similar to the second vehicle pose information.
I. The method of paragraph E, wherein the first vehicle pose information comprises at least three dimensional vehicle position coordinates.
J. The method of paragraph E, wherein the first vehicle pose information comprises at least vehicle roll, pitch, and yaw information.
K. The method of paragraph E, further comprising publishing, by the first computer system, a snapshot of the second vehicle pose information, the snapshot comprising the second vehicle pose information and a timestamp, to the second computer system to enable the second computer system to adjust the first vehicle pose information based on the second vehicle pose information.
L. The method of paragraph E, wherein publishing the first vehicle pose information for use by the first computer system and publishing the second vehicle pose information for use by the first computer system comprise publishing repeated vehicle pose information updates for use by the first computer system.
M. The method of paragraph E, wherein the at least one sensor comprises one or more of an inertial measurement unit, a wheel speed sensor, or a steering angle sensor.
N. One or more non-transitory computer-readable media storing instructions executable by a processor, wherein the instructions, when executed, cause the processor to perform operations comprising: publishing, by a second computer system, first vehicle pose information for use by a first computer system; wherein, in response to a fault at the second computer system, the second computer system discontinues publishing the first vehicle pose information and a third computer system provides second vehicle pose information for use by the first computer system; performing a fault recovery by the second computer system; determining, by the second computer system, the first vehicle pose information based on the second vehicle pose information; and resuming the publishing, by the second computer system, the first vehicle pose information for use by the first computer system.
O. The one or more non-transitory computer-readable media of paragraph N, wherein the operations further comprise: comparing the first vehicle pose information with the second vehicle pose information by the second computer system subsequent to determining the first vehicle pose information based on the second vehicle pose information; and confirming that first coordinates included in the first vehicle pose information are threshold similar to second coordinates included in the second vehicle pose information by being less than a threshold distance from the first coordinates.
P. The one or more non-transitory computer-readable media of paragraph N, wherein the operations further comprise: comparing the first vehicle pose information with the second vehicle pose information by the second computer system subsequent to determining the first vehicle pose information based on the second vehicle pose information; and confirming that one or more of a first roll, a first pitch, or a first yaw included in the first vehicle pose information is threshold similar to one or more of a second roll, second pitch, or second yaw included in the second vehicle pose information by being less than a threshold number of degrees different.
Q. The one or more non-transitory computer-readable media of paragraph N, wherein the second computer system independently calculates the first vehicle pose information based on information output from at least one inertial measurement unit.
R. The one or more non-transitory computer-readable media of paragraph Q, wherein the second computer system independently calculates the first vehicle pose information based further on information output from one or more of at least one wheel speed sensor and at least one steering angle sensor.
S. The one or more non-transitory computer-readable media of paragraph N, wherein publishing the first vehicle pose information for use by the first computer system comprises publishing repeated vehicle pose information updates for use by the first computer system.
T. The one or more non-transitory computer-readable media of paragraph N, wherein the operations further comprise receiving a snapshot of the second vehicle pose information from the first computer system, wherein determining the first vehicle pose information based on the second vehicle pose information is based on the snapshot.

While the example clauses described above are described with respect to particular examples, it should be understood that, in the context of this document, the content of the example clauses can be implemented via a method, device, system, a computer-readable medium, and/or another example. Additionally, any of examples A-T may be implemented alone or in combination with any other one or more of the examples A-T.

### CONCLUSION

While one or more examples of the techniques described herein have been described, various alterations, additions, permutations, and equivalents thereof are included within the scope of the techniques described herein.

In the description of examples, reference is made to the accompanying drawings that form a part hereof, which show by way of illustration specific examples of the claimed subject matter. It is to be understood that other examples may be used and that changes or alterations, such as structural changes, may be made. Such examples, changes or alterations are not necessarily departures from the scope with respect to the intended claimed subject matter. While the steps herein may be presented in a certain order, in some cases the ordering may be changed so that certain inputs are provided at different times or in a different order without changing the function of the systems and methods described. The disclosed procedures could also be executed in different orders. Additionally, various computations that are herein need not be performed in the order disclosed, and other examples using alternative orderings of the computations could be readily implemented. In addition to being reordered, the computations could also be decomposed into sub-computations with the same results.

Although the subject matter has been described in language specific to structural features and/or methodological acts, it is to be understood that the subject matter defined in the appended claims is not necessarily limited to the specific features or acts described. Rather, the specific features and acts are disclosed as example forms of implementing the claims.

The components described herein represent instructions that may be stored in any type of computer-readable medium and may be implemented in software and/or hardware. All of the methods and processes described above may be embodied in, and fully automated via, software code modules and/or computer-executable instructions executed by one or more computers or processors, hardware, or some combination thereof. Some or all of the methods may alternatively be embodied in specialized computer hardware.

Conditional language such as, among others, “may,” “could,” “may” or “might,” unless specifically stated otherwise, are understood within the context to present that certain examples include, while other examples do not include, certain features, elements and/or steps. Thus, such conditional language is not generally intended to imply that certain features, elements and/or steps are in any way required for one or more examples or that one or more examples necessarily include logic for deciding, with or without user input or prompting, whether certain features, elements and/or steps are included or are to be performed in any particular example.

Conjunctive language such as the phrase “at least one of X, Y or Z,” unless specifically stated otherwise, is to be understood to present that an item, term, etc. may be either X, Y, or Z, or any combination thereof, including multiples of each element. Unless explicitly described as singular, “a” means singular and plural.

Any routine descriptions, elements or blocks in the flow diagrams described herein and/or depicted in the attached figures should be understood as potentially representing modules, segments, or portions of code that include one or more computer-executable instructions for implementing specific logical functions or elements in the routine. Alternate examples are included within the scope of the examples described herein in which elements or functions may be deleted, or executed out of order from that shown or discussed, including substantially synchronously, in reverse order, with additional operations, or omitting operations, depending on the functionality involved as would be understood by those skilled in the art.

Many variations and modifications may be made to the above-described examples, the elements of which are to be understood as being among other acceptable examples. All such modifications and variations are intended to be included herein within the scope of this disclosure and protected by the following claims.

What is claimed is:

1. A vehicle comprising:
a first computer system comprising a primary compute node configured to generate trajectories for the vehicle;
a second computer system comprising an active motion compute node configured to control the vehicle to follow the trajectories and to generate first vehicle pose information; and
a third computer system comprising a backup motion compute node configured to control the vehicle to follow the trajectories and to generate second vehicle pose information;
wherein each of the first, second, and third computer systems comprises one or more processors and one or more computer-readable media storing computer-executable instructions;
wherein the instructions, when executed, implement an autonomous driving system that is configured for autonomous control of the vehicle; and
wherein the instructions, when executed, cause the first, second and third computer systems to perform operations comprising:
controlling, using the primary compute node and the active motion compute node, the vehicle in a first mode;
publishing, with the vehicle in the first mode and by the active motion compute node, the first vehicle pose information for use by the primary compute node;
in response to a fault at the active motion compute node, controlling, using the backup motion compute node, the vehicle in a safe mode;
publishing, with the vehicle in the safe mode and by the backup motion compute node, the second vehicle pose information for use by the primary compute node;
performing, with the vehicle in the safe mode, a fault recovery by the active motion compute node, the performing the fault recovery by the active motion compute node comprising:
receiving the second vehicle pose information; and
determining, by the active motion compute node and based on the second vehicle pose information, the first vehicle pose information;
resuming, based at least in part on performing the fault recovery, the controlling the vehicle in the first mode; and
resuming, based at least in part on performing the fault recovery, the publishing the first vehicle pose information for use by the primary compute node.

2. The vehicle of claim 1, wherein the operations further comprise:
subsequent to determining the first vehicle pose information based on the second vehicle pose information, comparing the first vehicle pose information with the second vehicle pose information by the active motion compute node,
wherein comparing the first vehicle pose information with the second vehicle pose information comprises confirming that the first vehicle pose information is threshold similar to the second vehicle pose information; and
publishing, by the active motion compute node to the primary compute node, an indication that the first vehicle pose information is threshold similar to the second vehicle pose information.

3. The vehicle of claim 1, wherein the first vehicle pose information and the second vehicle pose information comprise vehicle position coordinates and vehicle roll, pitch, and yaw information.

4. The vehicle of claim 1, wherein:
the active motion compute node independently calculates the first vehicle pose information based on information output from at least one sensor,
the backup motion compute node independently calculates the second vehicle pose information based on information output from the at least one sensor, and
the at least one sensor comprises one or more of an inertial measurement unit, a wheel speed sensor, or a steering angle sensor.

5. A method comprising:
independently calculating, by a second computer system, first vehicle pose information based on information output from at least one sensor;
independently calculating, by a third computer system, second vehicle pose information based on information output from the at least one sensor;
publishing, by the second computer system, the first vehicle pose information for use by a first computer system to enable the first computer system to perform one or more vehicle control functions;
in response to a fault at the second computer system, publishing, by the third computer system, the second vehicle pose information for use by the first computer system;
performing a fault recovery by the second computer system;
adjusting, by the second computer system, the first vehicle pose information based on the second vehicle pose information; and
resuming the independently calculating, by the second computer system, the first vehicle pose information and the publishing, by the second computer system, the first vehicle pose information for use by the first computer system.

6. The method of claim 5, wherein the independently calculating the first vehicle pose information is performed by an integrator-based solver at the second computer system.

7. The method of claim 5, further comprising comparing the first vehicle pose information with the second vehicle pose information by the second computer system in order to confirm that the first vehicle pose information is threshold similar to the second vehicle pose information.

8. The method of claim 7, further comprising publishing, by the second computer system to the first computer system, an indication that the first vehicle pose information is threshold similar to the second vehicle pose information.

9. The method of claim 5, wherein the first vehicle pose information comprises at least three dimensional vehicle position coordinates.

10. The method of claim 5, wherein the first vehicle pose information comprises at least vehicle roll, pitch, and yaw information.

11. The method of claim 5, further comprising publishing, by the first computer system, a snapshot of the second vehicle pose information, the snapshot comprising the second vehicle pose information and a timestamp, to the second computer system to enable the second computer system to adjust the first vehicle pose information based on the second vehicle pose information.

12. The method of claim 5, wherein publishing the first vehicle pose information for use by the first computer system and publishing the second vehicle pose information for use by the first computer system comprise publishing repeated vehicle pose information updates for use by the first computer system.

13. The method of claim 5, wherein the at least one sensor comprises one or more of an inertial measurement unit, a wheel speed sensor, or a steering angle sensor.

14. One or more non-transitory computer-readable media storing instructions executable by a processor, wherein the instructions, when executed, cause the processor to perform operations comprising:
publishing, by a second computer system, first vehicle pose information for use by a first computer system;
wherein, in response to a fault at the second computer system, the second computer system discontinues publishing the first vehicle pose information and a third computer system provides second vehicle pose information for use by the first computer system;
performing a fault recovery by the second computer system;
determining, by the second computer system, the first vehicle pose information based on the second vehicle pose information; and
resuming the publishing, by the second computer system, the first vehicle pose information for use by the first computer system.

15. The one or more non-transitory computer-readable media of claim 14, wherein the operations further comprise:
comparing the first vehicle pose information with the second vehicle pose information by the second computer system subsequent to determining the first vehicle pose information based on the second vehicle pose information; and
confirming that first coordinates included in the first vehicle pose information are threshold similar to second coordinates included in the second vehicle pose information by being less than a threshold distance from the first coordinates.

16. The one or more non-transitory computer-readable media of claim 14, wherein the operations further comprise:
comparing the first vehicle pose information with the second vehicle pose information by the second computer system subsequent to determining the first vehicle pose information based on the second vehicle pose information; and
confirming that one or more of a first roll, a first pitch, or a first yaw included in the first vehicle pose information is threshold similar to one or more of a second roll, second pitch, or second yaw included in the second vehicle pose information by being less than a threshold number of degrees different.

17. The one or more non-transitory computer-readable media of claim 14, wherein the second computer system independently calculates the first vehicle pose information based on information output from at least one inertial measurement unit.

18. The one or more non-transitory computer-readable media of claim 17, wherein the second computer system independently calculates the first vehicle pose information based further on information output from one or more of at least one wheel speed sensor and at least one steering angle sensor.

19. The one or more non-transitory computer-readable media of claim 14, wherein publishing the first vehicle pose information for use by the first computer system comprises publishing repeated vehicle pose information updates for use by the first computer system.

20. The one or more non-transitory computer-readable media of claim 14, wherein the operations further comprise receiving a snapshot of the second vehicle pose information from the first computer system, wherein determining the first vehicle pose information based on the second vehicle pose information is based on the snapshot.
